(19) United States
(12) Patent Application Publication
(10) Pub. No.: US 2024/0011735 A1
(43) Pub. Date: Jan. 11, 2024

(54) APPARATUS, SYSTEM AND METHOD FOR SECURELY RECEIVING A GUN HOLSTER

(71) Applicant: Jason Edward Savaria, Ballston Spa, NY (US)

(72) Inventor: Jason Edward Savaria, Ballston Spa, NY (US)

(21) Appl. No.: 18/090,143

(22) Filed: Dec. 28, 2022

Related U.S. Application Data
(60) Provisional application No. 63/358,592, filed on Jul. 6, 2022.

(51) Int. Cl. F41C 33/04; F16M 13/02

(52) U.S. Cl. CPC F41C 33/041; F16M 13/02

(57) ABSTRACT

A mounting apparatus for a gun holster includes a back plate, a front plate, and a slot intermediate the front plate and the back plate, the slot being configured to closely receive a belt clip of a gun holster.

### CROSS-REFERENCE TO RELATED APPLICATIONS

This application claims the benefit of U.S. Provisional Application Ser. No. 63/358,592, filed on Jul. 6, 2022, which is hereby incorporated reference herein in its entirety.

### FIELD OF THE INVENTION

The present invention relates generally to the stowing and securement of firearms such as pistols and revolvers and, more particularly, to an apparatus that receives and secures a firearm and holster.

### BACKGROUND OF THE INVENTION

Gun holsters are well known in the art and are generally designed to offer protection to a handgun, secure its retention, and provide ready access to it. Holsters typically include a pocket for receiving a handgun and a means for securing the holster, and handgun to the belt of a user. One common means that known holsters employ for securing the holster to a belt is a retention clip that reaches around and is complementary to a wearer's belt.

While holsters function well to allow a wearer ready access to a handgun and are easy to use, stowing the handgun and holster when not carried on a wearer's person can be cumbersome. In particular, the presence of the clip on the holster and lack of mounting means other than the clip often requires the holster clip and/or the entire handgun holster to be removed in order to securely store the handgun.

In view of the above, there is a need for an apparatus and system for securely receiving and mounting the handgun and holster when not carried on a wearer.

### SUMMARY OF THE INVENTION

Certain embodiments commensurate in scope with the originally claimed subject matter are summarized below. These embodiments are not intended to limit the scope of the claimed subject matter, but rather these embodiments are intended only to provide a brief summary of the possible embodiments. Indeed, the disclosure may encompass a variety of forms that may be similar to or different from the embodiments set forth below.

It is an object of the present invention to provide an apparatus for securely receiving a handgun and handgun holster.

It is another object of the present invention to provide an apparatus for securely receiving a handgun and handgun holster, and which can easily be mounted in a variety of locations and to a variety of surfaces.

In an embodiment, a mounting apparatus for a gun holster is provided. The mounting apparatus includes a back plate, a front plate, and a slot intermediate the front plate and the back plate, the slot being configured to closely receive a belt clip of a gun holster.

In another embodiment, a mounting apparatus for a gun holster is provided. The mounting apparatus includes a back plate, a front plate, the back plate and the front plate being interconnected between bottom portions of the front plate and the back plate, a slot intermediate the front plate and the back plate, the slot being configured to receive a belt clip of a gun holster, and a groove formed in an inward-facing surface of the front plate and being in communication with the slot, the groove being shaped and dimensioned to receive a distal end of the belt clip of the gun holster.

In yet another embodiment, a method of stowing a firearm holster is provided. The method includes the steps of mounting an apparatus to a vertical surface, the apparatus including a back plate, a front plate, and a slot intermediate the front plate and the back plate, and inserting a belt clip of a holster into the slot so that the belt clip is received intermediate the front plate and the back plate.

### BRIEF DESCRIPTION OF THE DRAWINGS

The present invention will be better understood from reading the following description of non-limiting embodiments, with reference to the attached drawings, wherein below:

FIG. 1 is an isometric view of a mounting apparatus, according to an embodiment of the present invention.

FIG. 2 is a front elevational view of the mounting apparatus of FIG. 1.

FIG. 3 is a side elevational view of the mounting apparatus of FIG. 1.

FIG. 4 is a top plan view of the mounting apparatus of FIG. 1.

FIG. 5 is a front view of a mounting apparatus in accordance with another embodiment of the present invention, illustrating use with a gun and gun holster.

FIG. 6 is a partial view of the mounting apparatus of FIG. 5.

FIG. 7 is a front view of the mounting apparatus of FIG. 5, shown prior to receiving the gun holster.

FIG. 8 is a front view of the mounting apparatus of FIG. 7 as it is being slid into engagement with the clip of the gun holster.

FIG. 9 is an isometric view of the mounting apparatus of FIG. 8 as it is being slid out of engagement with the clip of the gun holster.

FIG. 10 is an isometric view of the mounting apparatus of FIG. 5, shown attached to a bed rail, according to an embodiment of the present invention.

FIG. 11 is an isometric view of a mounting apparatus, according to another embodiment of the present invention.

FIG. 12 is a top plan view of the mounting apparatus of FIG. 11.

FIG. 13 is a partial view of the mounting apparatus within the circle A of FIG. 12.

FIG. 14 is a front elevational view of the mounting apparatus of FIG. 11.

FIG. 15 is a side view of the mounting apparatus of FIG. 11.

FIG. 16 is an isometric view of a mounting apparatus, in accordance with yet another embodiment of the present invention.

FIG. 17 is a side view of the mounting apparatus of FIG. 16.

FIG. 18 is a top plan view of the mounting apparatus of FIG. 16.

FIG. 19 is a partial view of the mounting apparatus within the circle A of FIG. 18.

FIG. 20 is a front elevational view of the mounting apparatus of FIG. 16, according to an embodiment of the present invention.

### DETAILED DESCRIPTION OF THE PREFERRED EMBODIMENT

Reference will be made below in detail to exemplary embodiments of the invention, examples of which are illustrated in the accompanying drawings. Wherever possible, the same reference characters used throughout the drawings refer to the same or like parts.

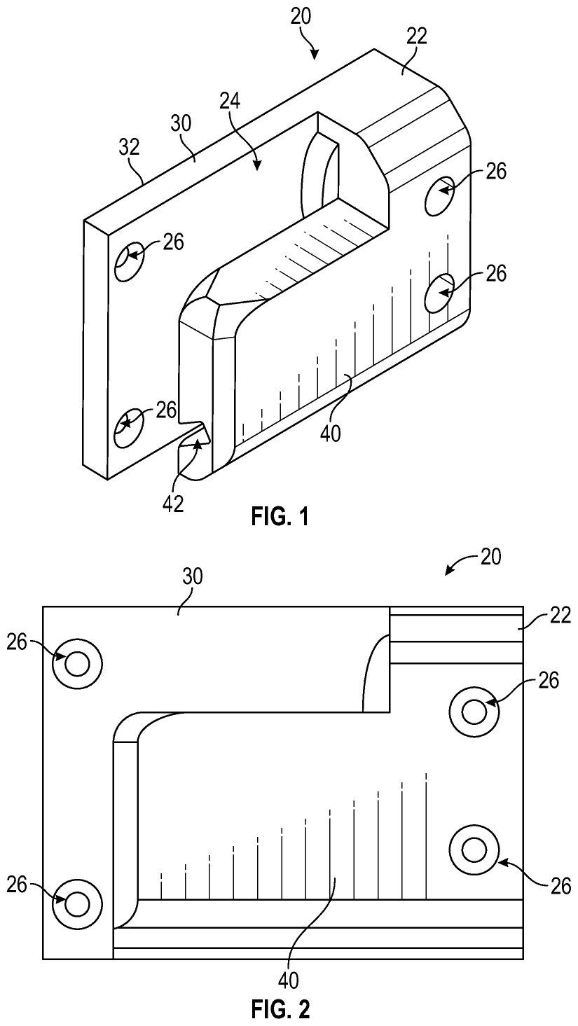

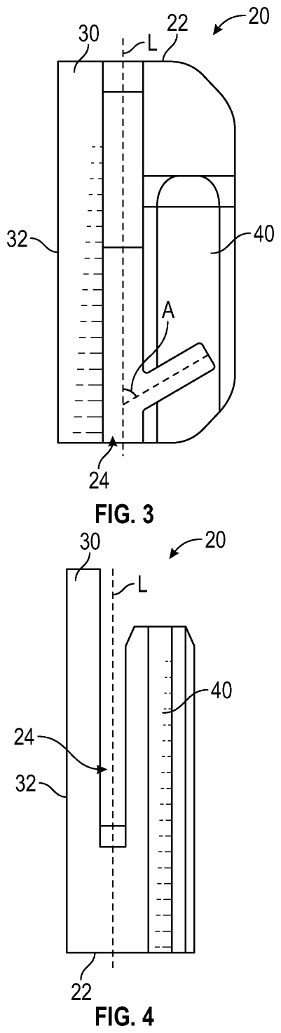

With reference to FIGS. 1-5, a mounting apparatus 20 for a gun holster (not depicted) according to an embodiment of the present invention is illustrated. As shown therein, the mounting apparatus 20 includes a back plate 30 and a front plate 40 spaced apart from the back plate 30 by a bracket extension 22 to define a slot or recess 24. The recess 24 is complementary in shape and width to a clip of a gun holster. Referring specifically to FIG. 2, the front plate 40 is interrupted by a groove 42 in the front plate 40 that is in communication with the slot or recess 24. In other words, the groove 42 penetrates an inner surface of the front plate 40 adjacent to the recess 24. In an embodiment, the recess 24 and groove 42 of the mounting apparatus 20 are dimensioned and configured to closely match the configuration of a clip of a gun holster. In particular, the recess 24 is dimensioned so as to closely receive the body of a clip of a handgun holster, while the groove 42 in the front plate 40 has a configuration that is selected to closely match the configuration of a distal end or protrusion 16 of the clip.

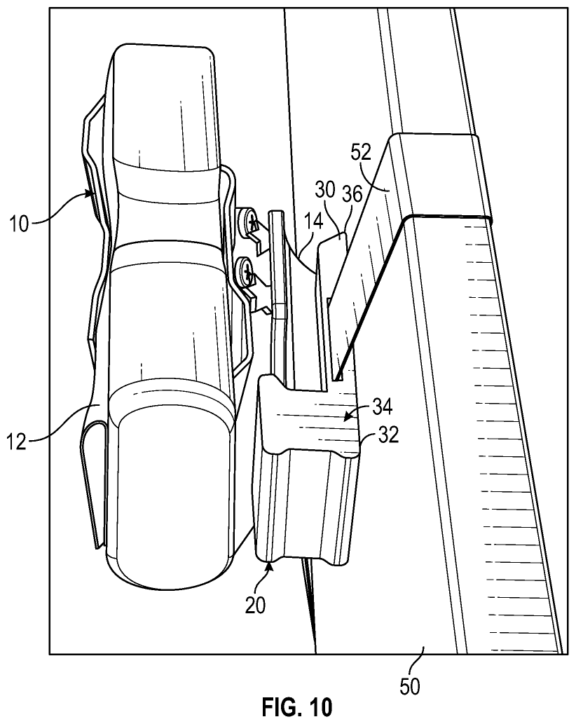

The back plate 30 provides a mounting surface 32 for securing the system 20 to an external surface such as, for example, a wall, a piece of furniture or a rail of a bed frame. In the embodiments depicted in FIGS. 1-10, the mounting surface 32 provides a flat surface that allows easy and convenient placement of the mounting apparatus 20 in a variety of locations. FIG. 10 depicts an example of the back plate 30 of the mounting apparatus 20 mounted flush against a flat side member 50 of a bed frame, but the mounting apparatus 20 is compatible with any surface that provides sufficient support to adequately secure to the mounting surface 32.

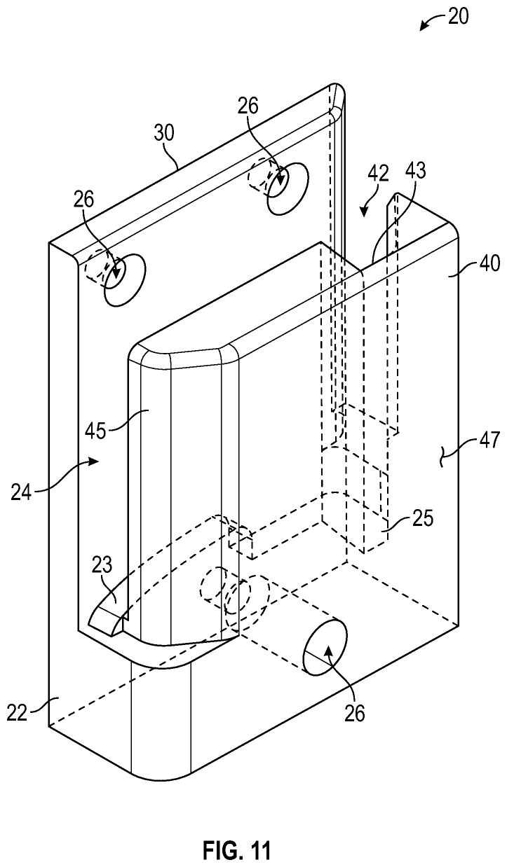

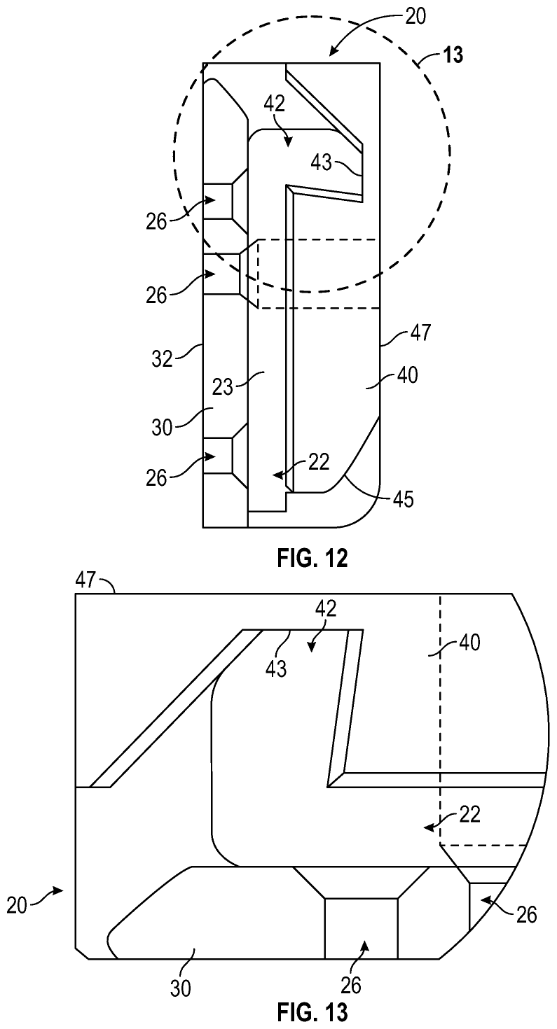

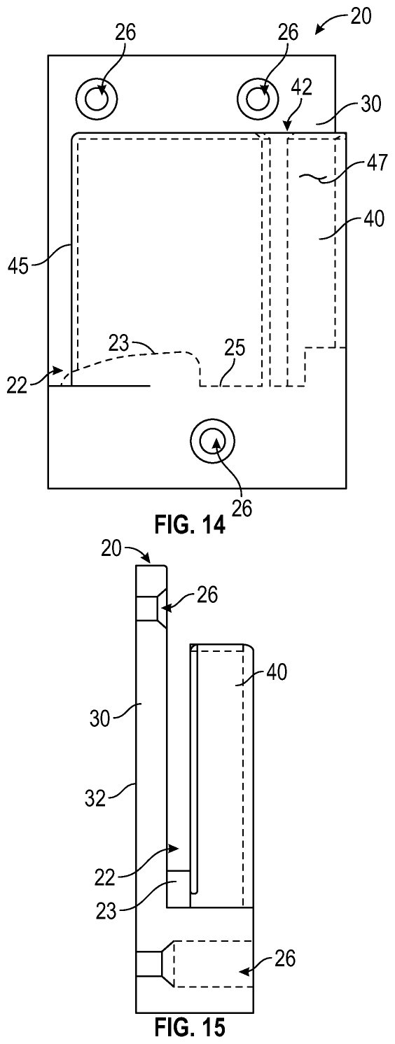

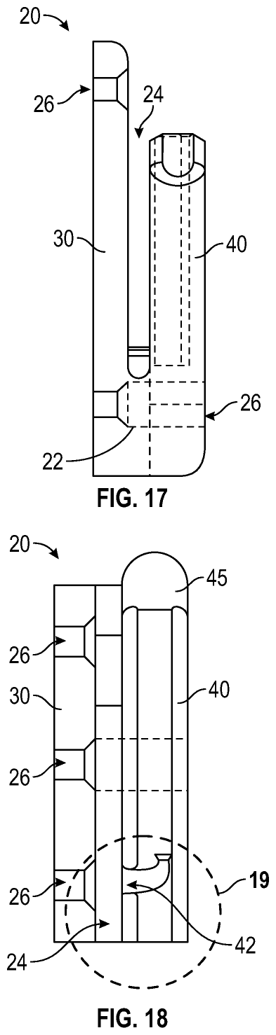

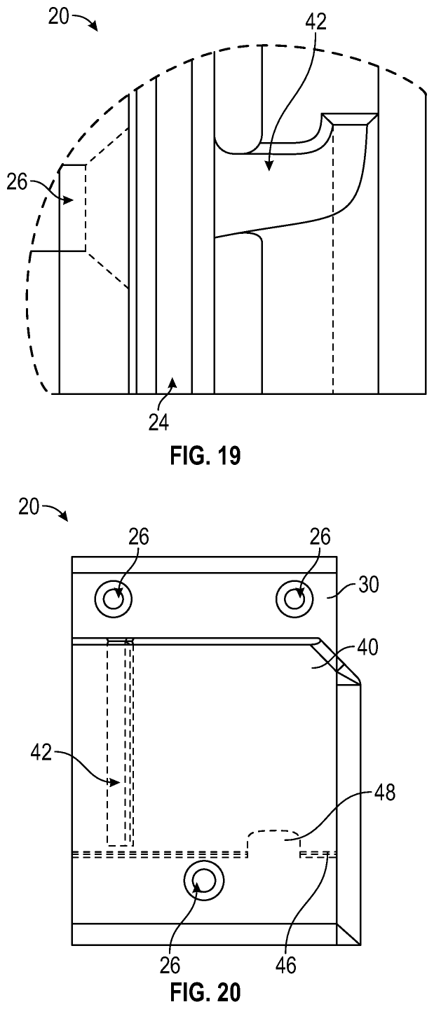

In the embodiment depicted in FIGS. 1-4, four mounting apertures 26 extend through the mounting apparatus 20, ultimately terminating at the mounting surface 32 of the back plate 30. Fasteners (not depicted), e.g., screws, reach through the mounting apertures 26 to secure the mounting surface 32 to a flat external surface. Referring to FIG. 2, two of the mounting apertures 26 only penetrate the back plate 30 and two of the mounting apertures 26 penetrate the back plate 30, the bracket extension 22, and the front plate 40. Alternate embodiments including a different number and/or arrangement of the apertures 26 do not significantly depart from the invention disclosed herein. In the embodiments depicted in FIGS. 11-20, three mounting apertures 26 extend through the mounting apparatus 20 with two of the mounting apertures 26 only penetrating the back plate and one of the mounting apertures 26 penetrating the back plate 30, the bracket extension 22, and the front plate 40.

In the embodiment depicted in FIGS. 1-4, the back plate 30 extends beyond the front plate 40 (as specifically depicted in FIG. 2) to provide additional space to accommodate the clip of the gun holster over the front plate 40 and into the recess 24 between the front plate 40 and the back plate 30. Referring to FIG. 4, the recess 24 has a cross-section that is generally C-shaped, when viewed from the top of the mounting apparatus 20. In the embodiment depicted in FIGS. 1-4, the front plate 40 has canted or otherwise rounded edges to ease insertion and removal of the holster clip within the recess.

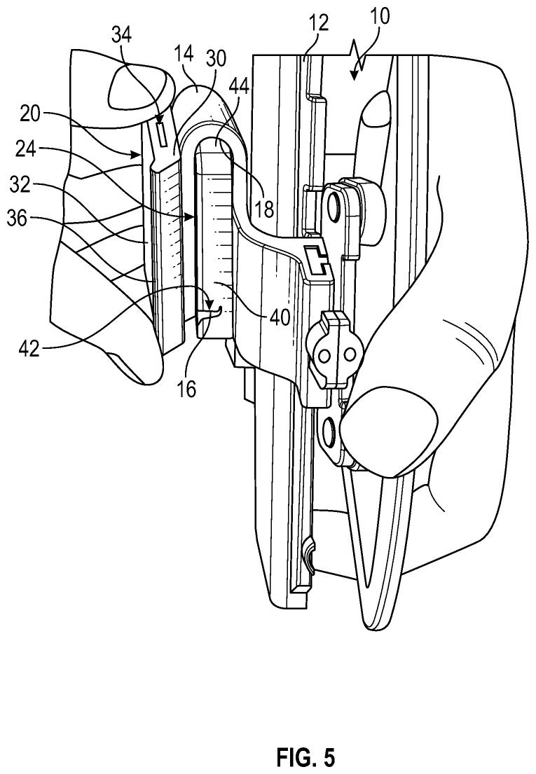

Referring to the embodiment depicted in FIGS. 5-10, the front plate 40 includes a top edge 44 complementary in shape to the clip of the holster. FIG. 5 specifically depicts the complementary shape of the top edge 44 of the front plate 40 and an inner surface 18 of the clip of the gun holster. The top edge 44 has a cross-section defined by an arcuate line.

In the embodiment of FIGS. 5-10, rather than having apertures 26 for receiving fasteners for securing the apparatus 20 to a flat surface, the back plate 30 of the apparatus 20 includes an elongated aperture 34 that receives a strap or belt 52 (as depicted in FIG. 10), allowing the back plate 30 to be affixed an external surface such as a bed rail. The elongated aperture 34 extends through the back plate 30 generally parallel to the mounting surface 32.

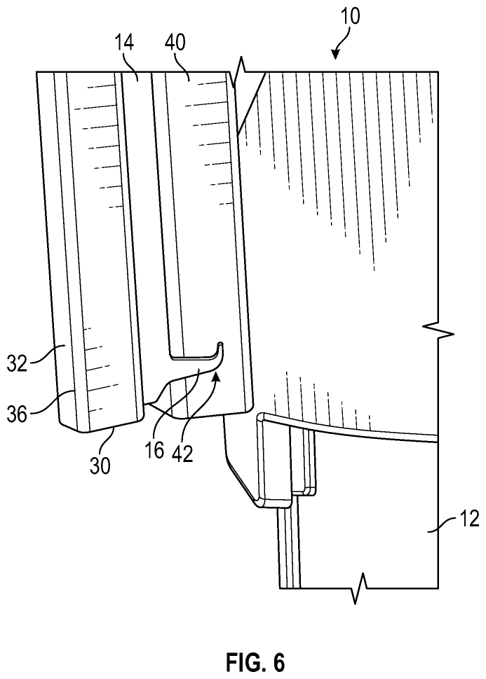

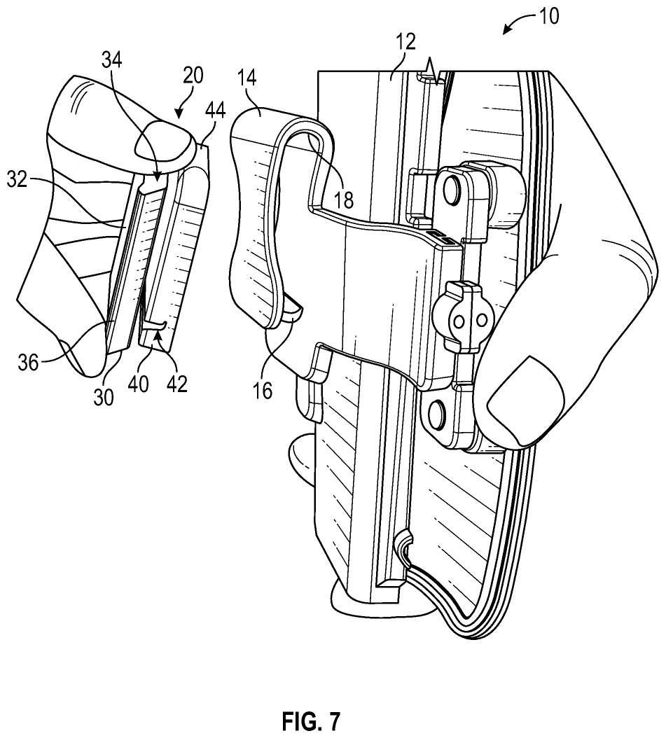

In the embodiment depicted in FIGS. 5-10, the groove 42 curves such that a cross-section of the groove 42 is complementary in shape to the protrusion 16 of the holster clip (as depicted in detail in FIG. 6).

In the embodiment depicted in FIGS. 5-10, the back plate 30 includes a leading edge 36 that helps the user insert and remove the clip of the gun holster within the recess 24. The leading edge 36 is angled to promote opening of the recess 24, by angularly deforming the back plate 30 away from the front plate 40, and to provide a more secure connection by maximizing the surface area of the mounting surface 32.

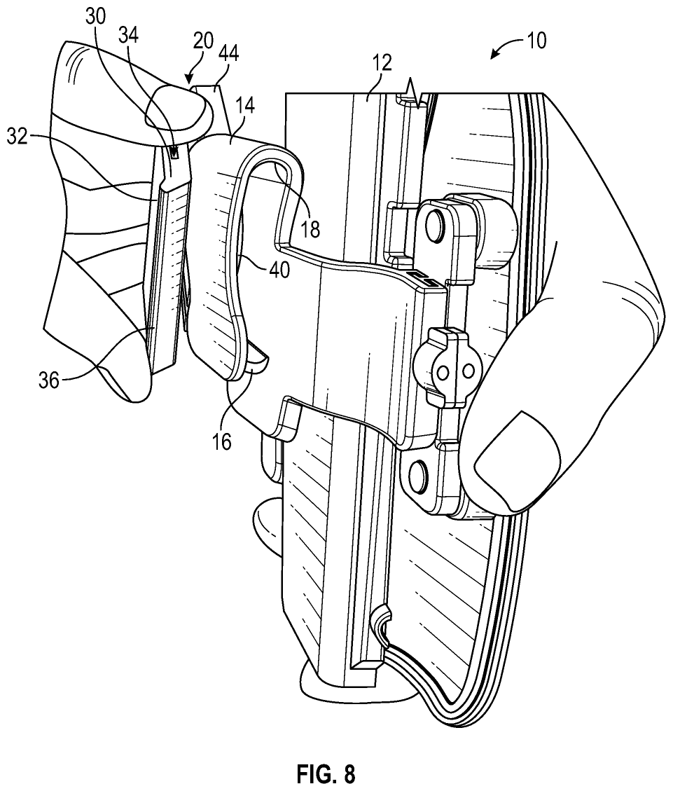

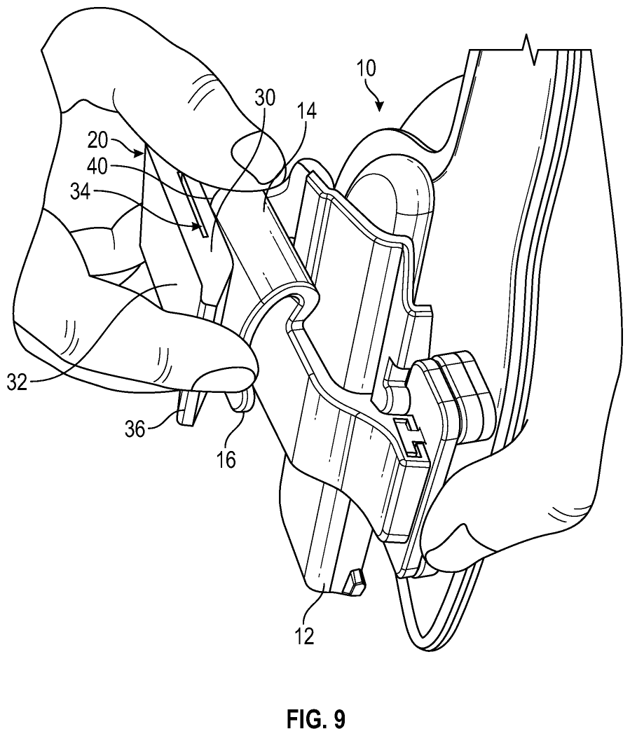

FIGS. 5-9 illustrate use of the mounting apparatus with a handgun 12 and holster. As shown in FIG. 7, a handgun 12 is received in the holster in a known manner. As shown, belt clip having distal protrusion 16 extends from the backside of the holster. As disclosed above, the slot 24 and groove 42 are generally complimentary in profile to the profile of the clip and distal protrusion 16. With reference to FIGS. 8 and 9, to couple the holster and handgun 12 to the mounting apparatus 20, the clip of the holster is aligned with the slot 24 in the mounting apparatus 20. The clip is then slid into the slot and pushed downwardly until the clip contacts the bracket extension 22. As best shown in FIGS. 5 and 6, the clip and distal protrusion 16 are thus closely received in the slot 24 and groove 42, securely coupling the holster to the mounting apparatus 20. As will be appreciated, the fairly tight tolerances of the slot 24 and groove 42 ensure that there is not much play or movement of the holster with respect to the mounting apparatus 20. As will be appreciated, to remove the holster and handgun 12 from the mounting apparatus 20, a user simply slides the clip out of the slot 24. The holster and handgun can then be attached to the belt of a user in the customary manner.

It is contemplated that the shape and width of the slot 24 is selected to closely correspond to the shape and width of the clip of a holster, and that the groove 42 is likewise shaped and dimensioned to closely correspond to the configuration and profile of the distal end of the clip (which may vary based on holster model and manufacturer). It is further contemplated that the mounting apparatus 20 of the present invention may be manufactured from a variety of materials such as, for example, metals, polymers and the like (e.g., aluminum).

As indicated above, the particular shape and dimensions of the slot 24 and groove 42 may be selected so as to closely correspond or match the shape, configuration and dimensions of the clip of a particular holster, which may vary from manufacturer to manufacturer or model to model. FIGS. 11-20 illustrate additional exemplary embodiments of the mounting apparatus 20 in which the structure of the mounting apparatus 20 differs slightly in order to accommodate holsters of different shapes and configurations (i.e., different holster models and manufacturers). In the embodiment depicted in FIGS. 11-15, in one embodiment of the mounting apparatus 20, the groove 42 has a generally triangular cross-section with a flattened groove tip 43. The opposing sides of the groove 42 are oriented at different angles relative to an outer surface 47 of the front plate 40. In this embodiment, the groove tip 43 is oriented substantially parallel to the outer surface 47 of the front plate 40. The groove 42 is also stepped in this configuration (as depicted in FIG. 11). In other words, the groove 42 does not have a constant cross-sectional shape, traveling between an upper end of the front plate 40 and the bracket extension 22, with the groove 42 tapering to a cross-section having a smaller surface area adjacent to the bracket extension 22.

In the embodiment depicted in FIGS. 11-15, the bracket extension 22 has a bracket edge 23 that projects into the slot 24 to provide for a smooth, angled, and/or arcuate surface to ease insertion and/or removal of the holster of the handgun 12 from the mounting apparatus 20. In the embodiment depicted in FIGS. 11-15, the bracket edge 23 is an arcuate surface that guides the holster into the slot 24. In the depicted embodiment, the bracket edge 23 extends from the bracket extension 22 to the groove 42 and defines a bracket basin 25 that receives and retains the holster within the slot 24. In the depicted embodiment, the bracket basin 25 is defined by an “L” shaped cross-section. The cross-section of the bracket basin 25 and/or the cross-section of the groove 42 are specifically tailored to receive and retain the holster of the handgun. In some embodiments, the bracket basin 25 and/or the groove 42 are compatible with a variety of holsters having different shapes. Incorporating a bracket basin 25 and/or a groove 42 having a different shape does not depart from the invention disclosed herein.

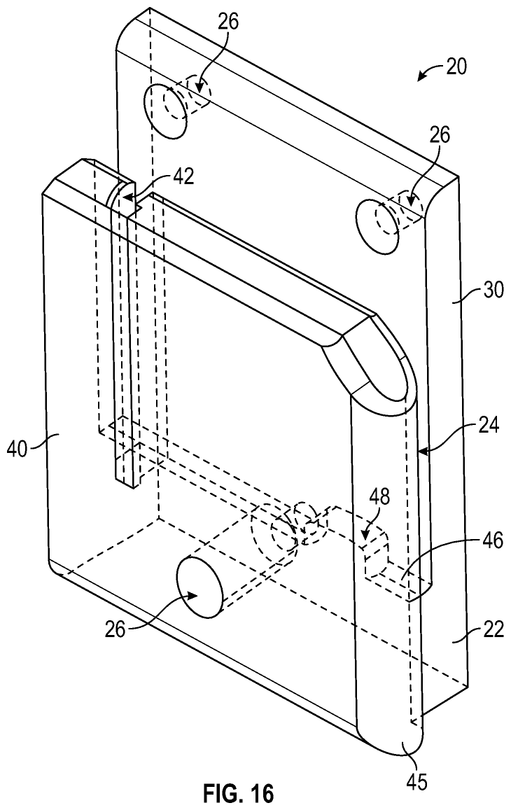

In the embodiment depicted in FIGS. 16-20, in another embodiment of the mounting apparatus 20, the inner surface of the front plate 40 defines a receiver ledge 46 that extends from the groove 42 to an edge 45 of the mounting apparatus 20. The receiver ledge 46 provides a surface that accommodates a side of the clip of the gun holster. A user inserts a clip of a gun holster into the slot 24 of the mounting apparatus 20 by sliding the protrusion 16 of the clip along the groove 42 until the side of the clip abuts the receiver ledge 46. In the depicted embodiment, the receiver ledge 46 is interrupted by a receiver protrusion 48 adjacent to one of the mounting apertures 26. The receiver protrusion 48 is configured to receive and retain additional protrusions (not depicted) on the clip of a gun holster to provide for sturdier mounting that is more difficult to inadvertently disengage. In the embodiments depicted in FIGS. 16-20, the edge 45 of the front plate 40 is curved to ease insertion/removal of the holster clip and/or to more comfortably accommodate the hand of a user.

As indicated, these embodiments are intended only to be exemplary, and various other modifications may be made to the configuration of the apparatus 20 to enable the apparatus 20 to receive belt clips of holsters from a variety of different manufacturers and a variety of different models. With any configuration, it is important that the slot 24 and groove 42 be configured and dimensioned so as to closely and securely receive the clip of the holster so as to provide for a reliable and secure engagement where the holster will not rock or wobble.

While it has been disclosed that screws or straps may be utilized to mount the mounting apparatus 20 to a surface, it is not intended that the present invention be so limited in this regard. In particular, it is contemplated that a variety of different mounting means can be employed such as, for example, double-sided tape, adhesive, Velcro, magnets, and the like.

The mounting apparatus 20 of the present invention therefore provides a means of securely mounting and stowing a handgun and holster, together, in a variety of locations without the need to remove the handgun from the holster. As disclosed above, the mounting apparatus 20 may be tailored to the unique form of various belt clips so that the mounting apparatus 20 captures the unique form of the belt clip, and with a sliding motion pressing into the slot 24, secures the belt clip inside the slot 24. Due to the apparatus' unique mating form to the belt clip, the belt clip will not be able to rock back and forth, will not be able to move up or down, thus securing the holster in the grip of the mounting apparatus 20. As disclosed, located in the recess of the apparatus 20 is a radius feature. This feature captures the radius of the belt clip and locates the clip inside the apparatus 20 ensuring a correct, snug fit.

In an embodiment, a mounting apparatus for a gun holster includes a back plate, a front plate, and a slot intermediate the front plate and the back plate, the slot being configured to closely receive a belt clip of a gun holster. In an embodiment, the mounting apparatus further includes a groove in an inner surface of the front plate and in communication with the slot, the groove being shaped and dimensioned to receive a distal end of the belt clip of the gun holster. In an embodiment, the groove has a crescent shape. In an embodiment, the mounting apparatus also includes a bracket extension connecting the front plate and the back plate. In an embodiment, the back plate provides a mounting surface for securing the mounting apparatus to an external surface. In an embodiment, the front plate includes a top edge complementary in shape to the belt clip of the gun holster. In an embodiment, the back plate includes at least one aperture, the at least one aperture being configured to receive a fastener allowing the back plate to be affixed an external surface. In an embodiment, the mounting apparatus includes a Velcro strap configured for engagement with a slot in the back plate. In an embodiment, the mounting apparatus if formed from metal. In an embodiment, the groove further includes a groove tip configured to receive a distal tip of the belt clip of the gun holster. In an embodiment, the groove has a cross-section that is triangular and includes a groove tip, the groove tip interrupting the triangular shape of the cross-section. In an embodiment, opposing sides of the groove are oriented at different angles relative to the inner surface of the front plate. In an embodiment, the groove has a truncated triangular cross-section. In an embodiment, the groove has a cross-section that varies over a longitudinal extent of the groove. In an embodiment, an area of a cross-section of the groove adjacent an upper end of the groove is greater than an area of a cross-section of the groove adjacent to a bottom end of the groove. In an embodiment, the inner surface of the front plate further includes a receiver ledge, the receiver ledge accommodating a side of the belt clip of the gun holster. In an embodiment, the receiver ledge further includes a receiver protrusion, the receiver protrusion configured to engage a protrusion of the clip of the gun holster.

In another embodiment, a mounting apparatus for a gun holster includes a back plate, a front plate, the back plate and the front plate being interconnected between bottom portions of the front plate and the back plate, a slot intermediate the front plate and the back plate, the slot being configured to receive a belt clip of a gun holster, and a groove formed in an inward-facing surface of the front plate and being in communication with the slot, the groove being shaped and dimensioned to receive a distal end of the belt clip of the gun holster. In an embodiment, the groove is crescent shaped.

In yet another embodiment a method of stowing a firearm holster includes the steps of mounting an apparatus to a vertical surface, the apparatus including a back plate, a front plate, and a slot intermediate the front plate and the back plate, and inserting a belt clip of a holster into the slot so that the belt clip is received intermediate the front plate and the back plate.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A mounting apparatus for a gun holster, the mounting apparatus comprising:
a back plate;
a front plate; and
a slot intermediate the front plate and the back plate, the slot being configured to closely receive a belt clip of a gun holster.

2. The mounting apparatus of claim 1, further comprising:
a groove in an inner surface of the front plate and in communication with the slot, the groove being shaped and dimensioned to receive a distal end of the belt clip of the gun holster.

3. The mounting apparatus of claim 2, wherein:
the groove has a crescent shape.

4. The mounting apparatus of claim 1, further comprising:
a bracket extension connecting the front plate and the back plate.

5. The mounting apparatus of claim 1, wherein:
the back plate provides a mounting surface for securing the mounting apparatus to an external surface.

6. The mounting apparatus of claim 1, wherein:
the front plate includes a top edge complementary in shape to the belt clip of the gun holster.

7. The mounting apparatus of claim 1, wherein:
the back plate includes at least one aperture, the at least one aperture being configured to receive a fastener allowing the back plate to be affixed an external surface.

8. The mounting apparatus of claim 1, further comprising:
a Velcro strap configured for engagement with a slot in the back plate.

9. The mounting apparatus of claim 1, wherein:
the mounting apparatus if formed from metal.

10. The mounting apparatus of claim 1, wherein:
the groove further includes a groove tip configured to receive a distal tip of the belt clip of the gun holster.

11. The mounting apparatus of claim 10, wherein:
the groove has a cross-section that is triangular and includes a groove tip, the groove tip interrupting the triangular shape of the cross-section.

12. The mounting apparatus of claim 10, wherein:
opposing sides of the groove are oriented at different angles relative to the inner surface of the front plate.

13. The mounting apparatus of claim 10, wherein:
the groove has a truncated triangular cross-section.

14. The mounting apparatus of claim 10, wherein:
the groove has a cross-section that varies over a longitudinal extent of the groove.

15. The mounting apparatus of claim 14, wherein:
an area of a cross-section of the groove adjacent an upper end of the groove is greater than an area of a cross-section of the groove adjacent to a bottom end of the groove.

16. The mounting apparatus of claim 1, wherein:
the inner surface of the front plate further includes a receiver ledge, the receiver ledge accommodating a side of the belt clip of the gun holster.

17. The mounting apparatus of claim 17, wherein the receiver ledge further includes a receiver protrusion, the receiver protrusion configured to engage a protrusion of the clip of the gun holster.

18. A mounting apparatus for a gun holster, comprising:
a back plate;
a front plate, the back plate and the front plate being interconnected between bottom portions of the front plate and the back plate;
a slot intermediate the front plate and the back plate, the slot being configured to receive a belt clip of a gun holster; and
a groove formed in an inward-facing surface of the front plate and being in communication with the slot, the groove being shaped and dimensioned to receive a distal end of the belt clip of the gun holster.

19. The mounting apparatus of claim 18, wherein:
the groove is crescent shaped.

20. A method of stowing a firearm holster, comprising the steps of:
mounting an apparatus to a vertical surface, the apparatus including a back plate, a front plate, and a slot intermediate the front plate and the back plate; and
inserting a belt clip of a holster into the slot so that the belt clip is received intermediate the front plate and the back plate.
